(19) United States
(12) Patent Application Publication
(10) Pub. No.: US 2022/0151156 A1
(43) Pub. Date: May 19, 2022

(54) METHOD AND APPARATUS AND SYSTEM FOR TRANSPORTING ITEMS USING A ROBOTIC VEHICLE

(71) Applicant: ADVANCED INTELLIGENT SYSTEMS INC., Burnaby (CA)

(72) Inventors: Farhang Bidram, West Vancouver (CA); Shahram Pourazadi, Burnaby (CA); Keith Chow, Richmond (CA); Milad Zarrinderakht, Coquitlam (CA)

(21) Appl. No.: 17/442,307

(22) PCT Filed: Mar. 23, 2020
(86) PCT No.: PCT/CA2020/050383

§ 371 Date: Sep. 23, 2021

Related U.S. Application Data
(60) Provisional application No. 62/826,398, filed on Mar. 29, 2019.
(60) Provisional application No. 62/843,333, filed on May 3, 2019.

(51) Int. Cl. A01D 90/16; A01D 90/02; A01D 41/127; A01G 25/16; G05D 1/02; G06K 7/10; G06K 19/07

(52) U.S. Cl. CPC A01D 90/16; A01D 90/02; A01D 41/1275; G05D 2201/0201; G05D 1/028; G06K 7/10386; G06K 19/0723; A01G 25/167

(57) ABSTRACT

A robotic vehicle apparatus for transporting a harvested crop within a cultivation area is disclosed and includes a vehicle controller operably configured to receive a pickup signal indicating that a harvested crop portion is available for transport to a post-harvesting location and identifying a location of a worker within the cultivation area. The vehicle controller navigates the vehicle to the location of the worker for loading the harvested crop portion into a load carrying repository and generates an identifier attributing the harvested crop portion to the worker. A quantity sensor is operable to produce a quantity signal representative of a quantity of the harvested crop portion loaded and the vehicle controller transmits quantity data to a host controller including the quantity of the harvested crop portion and the identifier. A method for navigating a robotic vehicle within an area having items arranged in a plurality of generally longitudinally extending adjacent rows is also disclosed.

### RELATED APPLICATIONS

This application claims the benefit of provisional patent application 62/826,398 entitled “SYSTEM AND METHOD FOR PRODUCE COLLECTION IN POST-HARVESTING”, filed on Mar. 29, 2019 and incorporated herein by reference in its entirety. This application also claims the benefit of provisional patent application 62/843,333 entitled “SYSTEM AND METHOD FOR IN-FIELD LOCALIZATION USING RFID TAGS”, filed on May 3, 2019 and incorporated herein by reference in its entirety.

### BACKGROUND

### 1. Field

This disclosure relates generally to operations using robotic vehicles and more particularly to a robotic vehicle apparatus, host controller, and method for transporting items within an area.

### 2. Description of Related Art

Robotic vehicles may be used to pick up items within an area and transport the items to another location for further processing. For example, when harvesting a crop within a cultivation area, the crop may be harvested manually or by an automated harvester and accumulated at various locations throughout the cultivation area. Further processing or post-processing of the crop generally occurs at another location that may be within or near the cultivation area. The harvested crops thus need to be transported from the various locations in the cultivation area where they have been accumulated to the post-processing location.

Some crops such as soft fruits spoil easily and require careful handling during harvesting and transportation to prevent spoilage. Conventional manual harvesting usually involves requiring workers to manually carry containers some distance to a drop-off point, such as a bulk transport vehicle within the cultivation area.

Robotic vehicles may be conveniently navigated using within an area using a combination of sensors and wireless positioning signals. In some cases, wireless positioning signals may not be available due to lack of communication network coverage, obstructions such as trees or other structures that may impede the usability and/or accuracy of satellite-based navigation systems such as GPS (Global Positioning System).

### SUMMARY

In accordance with one disclosed aspect there is provided a robotic vehicle apparatus for transporting a harvested crop within a cultivation area, the vehicle including a vehicle controller disposed on the vehicle and operably configured to receive a pickup signal indicating that a harvested crop portion is available for transport to a post-harvesting location, the pickup signal identifying a location of a worker within the cultivation area. The vehicle controller is further operably configured to automatically navigate the vehicle to the location of the worker for loading the harvested crop portion into a load carrying repository of the vehicle, and to generate an identifier attributing the harvested crop portion to the worker. The vehicle also includes a quantity sensor operable to produce a quantity signal representative of a quantity of the harvested crop portion loaded into the repository, the vehicle controller being operably configured to receive the quantity signal and to transmit quantity data to a host controller, the quantity data including the quantity of the harvested crop portion and the identifier attributing the harvested crop portion to the worker. The vehicle controller is further operably configured to cause the robotic vehicle to return to the post-harvesting location for unloading the harvested crop portion.

The apparatus may include a reader disposed on the vehicle and in communication with the vehicle controller, the reader being operable to generate the identifier attributing the harvested crop portion to the worker by reading at least one of a worker identification carried by the worker, and a container identification associated with a container in which the harvested crop portion has been accumulated.

The reader may include a radio frequency identifier (RFID) reader and at least one of the worker identification and the container identification may include an RFID transponder.

In response to arriving at a location proximate the location of the worker provided by the pickup signal, the vehicle controller may be operably configured to cause the reader to attempt to locate RFID transponders in range and to navigate to the location of the RFID transponder.

The harvested crop portion may be accumulated in a container placed by the worker at the identified location of the worker in the pickup signal, the vehicle controller being operably configured to, at a location proximate to the location of the worker, monitor the reader to determine proximity to the container, and maneuver the vehicle to position the vehicle for loading the container.

The vehicle may further include an automated loader operable to grasp the container for loading the harvested crop portion into the load carrying repository of the vehicle when the vehicle is positioned for loading the container.

The apparatus may include a radio frequency identifier (RFID) reader disposed on the vehicle and in communication with the vehicle controller, and a plurality of RFID transponders may be distributed within the cultivated area, and the vehicle controller may be further operably configured to detect when one of the plurality of RFID transponders is within range of the reader for use in navigating the vehicle to the location of the worker.

The vehicle may include at least one navigation sensor in communication with the vehicle controller and the vehicle controller may be operably configured to navigate the vehicle when outside the range of any of the plurality of RFID transponders.

The pickup signal may be initiated by the worker activating a wireless communications device, the wireless communications device being operably configured to transmit the pickup signal to at least one of the host controller and the vehicle controller.

The wireless communications device may be operably configured to determine geographic location information representative of the location of the worker and the pickup signal may include the geographic location information.

The pickup signal may be transmitted by the wireless communications device to one of: a receiver in communication with the host controller, the host controller being configured to relay the pickup signal to the vehicle controller, and a receiver disposed on the vehicle, the receiver being in communication with the vehicle controller.

The pickup signal may be initiated by the host controller based on an estimated period of time that the worker will take to make the harvested crop portion available for transport.

The load carrying repository may include an enclosed volume for receiving and storing harvested crop portions, the enclosed volume being operable to reduce exposure of the harvested crop to environmental conditions during transport to the post-harvesting location.

The apparatus may include an environmental control disposed in communication with the enclosed volume, the environmental control being operable to control at least one environmental condition within the enclosed volume.

The environmental control may include at least one of a humidity control, operably configured to regulate a humidity level within the enclosed volume, a sprayer operably configured to spray liquid over harvested crops within the enclosed volume, and a cooling source, operably configured to regulate a temperature within the enclosed volume.

The load carrying repository may include an actuated access port that is controlled by the vehicle controller to open to provide access for loading harvested crop portions into the enclosed volume and to close on completion of the loading.

The vehicle controller may be operably configured to cause the robotic vehicle to return to the post-harvesting location for unloading the harvested crop portion when the repository has reached a load carrying capacity based on the quantity signal.

In accordance with another disclosed aspect there is provided a host controller apparatus for monitoring a plurality of robotic vehicles transporting harvested crops within a cultivation area as defined above. The host controller apparatus includes a receiver operably configured to receive quantity data from the vehicles, the quantity data including quantities of harvested crop portions and an identifier attributing each harvested crop portion to a worker within the cultivation area. The host controller further includes a host processor circuit in communication with the receiver, the host processor circuit including a memory for storing codes that direct the processor circuit to implement a management database, the management database being operably configured store quantity data for each worker. The memory further stores codes that direct the host processor circuit to implement a management function that determines a total harvested crop quantity for each worker and generates data indicative of a remuneration owing to each worker based on the total harvested crop quantity.

The host processor circuit may be remotely located and may be in communication with the host controller via a network.

The processor circuit may be operably configured to receive routing and performance data from each of the vehicles and to use the data to optimize routing of the vehicles within the cultivated area.

In accordance with another disclosed aspect there is provided a method for navigating a robotic vehicle within an area having items arranged in a plurality of generally longitudinally extending adjacent rows, the area including access pathways interposed between each of the adjacent rows and a connecting pathway connecting between the access pathways, a radio frequency identifier (RFID) transponder disposed proximate an end of each row and proximate the connecting pathway, the RFID transponder being a member of a plurality of fixed location RFID transponders. The method involves receiving a pickup signal at a vehicle controller of the robotic vehicle, the pickup signal identifying a target access pathway where one or more of the items to be picked up by the vehicle are located. The method further involves causing the vehicle controller to automatically navigate the vehicle along the connecting pathway while detecting RFID transponders that are in-range of an RFID reader of the vehicle. The RFID transponders that are members of the plurality of fixed location RFID transponders are each configured such that respective transmission ranges of RFID transponders associated with adjacent rows have an overlap region proximate a junction between the connecting pathway and the access pathway. The method also involves, in response to simultaneously detecting a pair of RFID transponders that correspond to the adjacent rows associated with the target access pathway, causing the vehicle to enter and automatically navigate along the target access pathway, and while navigating along the target access pathway, locating the one or more items for pickup in response to detecting a target RFID transponder that is in-range of the RFID reader of the vehicle and is not one of the plurality of fixed location RFID transponders.

Receiving the pickup signal may involve receiving a pickup signal initiated in response to a worker activating a communications device to transmit the pickup signal, the worker being located on the access pathway.

Receiving the pickup signal may involve receiving a pickup signal from a host controller, the pickup signal transmitted by the communications device of the worker being received by the host controller and relayed to the vehicle controller.

The target RFID transponder may involve an RFID transponder associated with one of an item to be picked up, a container operable to accumulated items to be picked up, the worker that initiated the pickup signal, and the communications device of worker that initiated the pickup signal.

The fixed location plurality of RFID transponders may further include at least one RFID transponder disposed within each row and spaced apart along the row with respect to the RFID transponder proximate the end of the row, such that respective transmission ranges of RFID transponders associated with adjacent rows have an overlap region on the access pathway interposed between each of the adjacent rows.

The communications device may include an RFID reader and the transmitted pickup signal may include an identification of an adjacent pair of RFID transponders detected by the RFID reader.

Other aspects and features will become apparent to those ordinarily skilled in the art upon review of the following description of specific disclosed embodiments in conjunction with the accompanying figures.

### BRIEF DESCRIPTION OF THE DRAWINGS

In drawings which illustrate disclosed embodiments,

FIG. 1 is a perspective view of a robotic vehicle apparatus in accordance with a first disclosed embodiment;

FIG. 2A is a perspective view of a robotic vehicle apparatus in accordance with another disclosed embodiment;

FIG. 26 is a perspective view of the robotic vehicle apparatus of FIG. 2A being loaded;

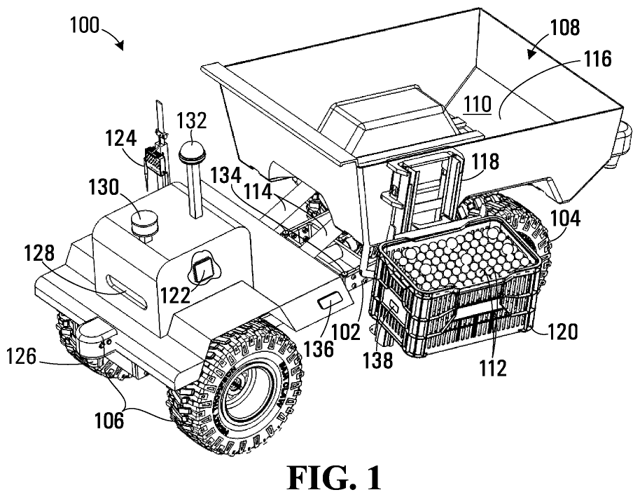

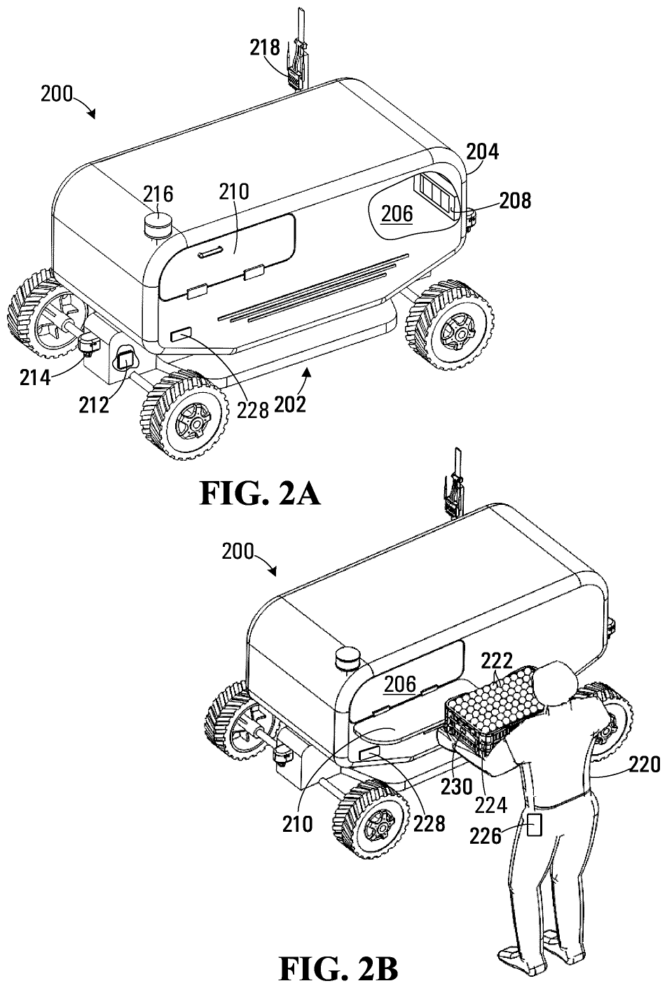

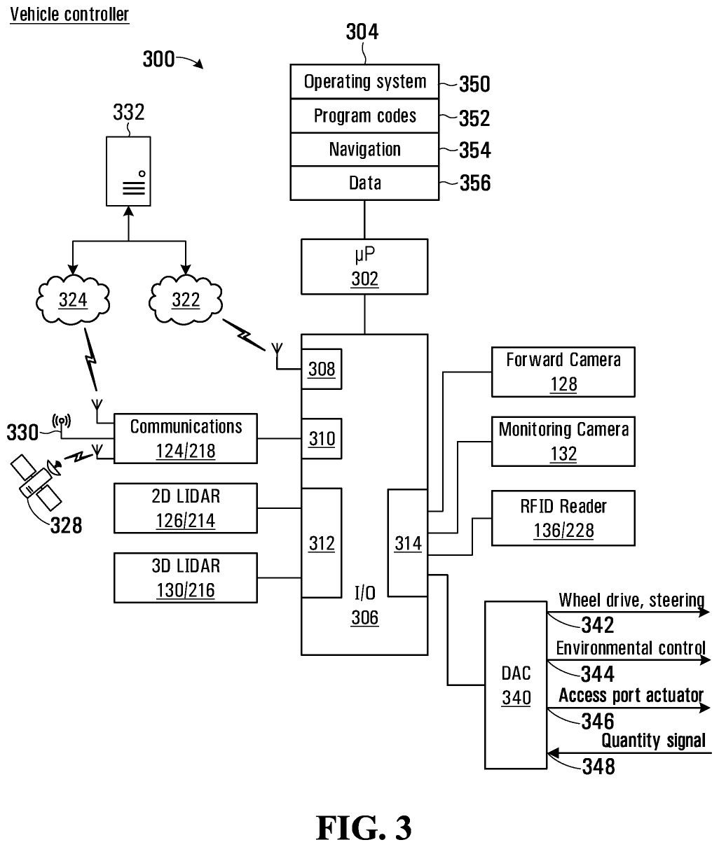

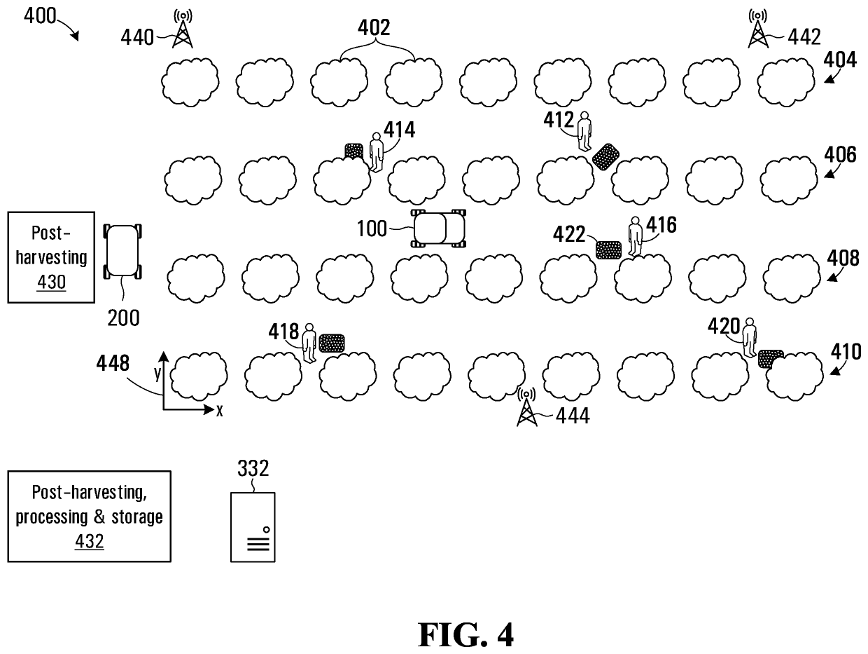

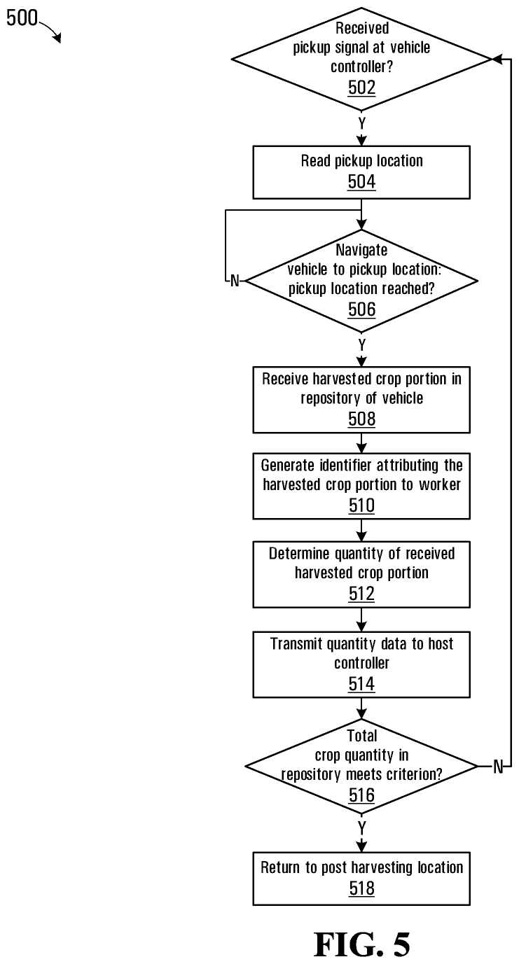

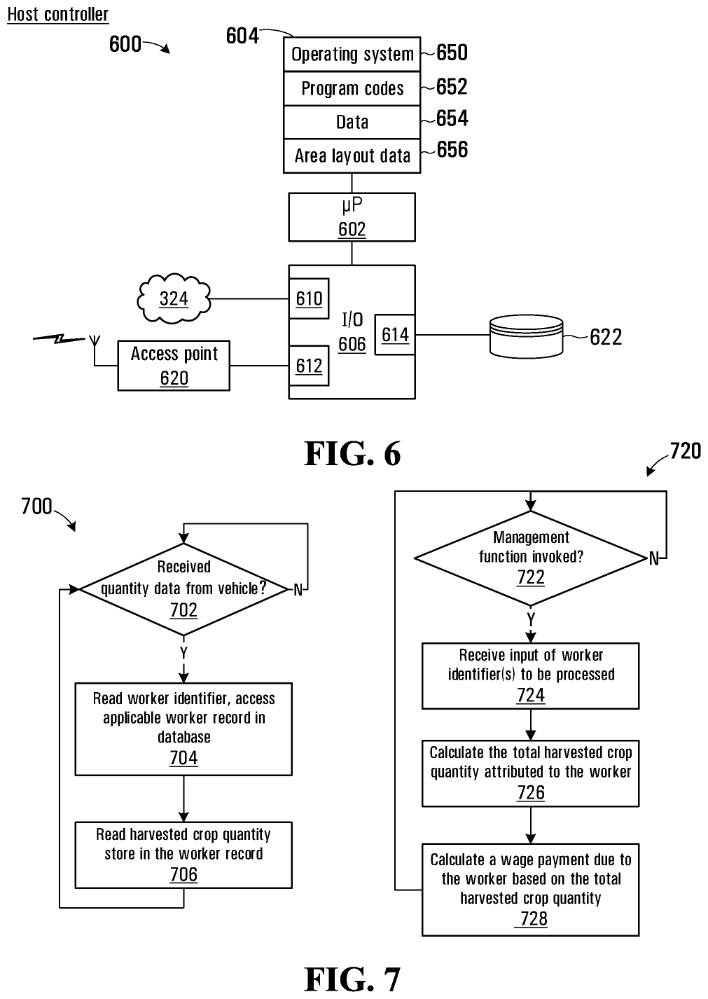

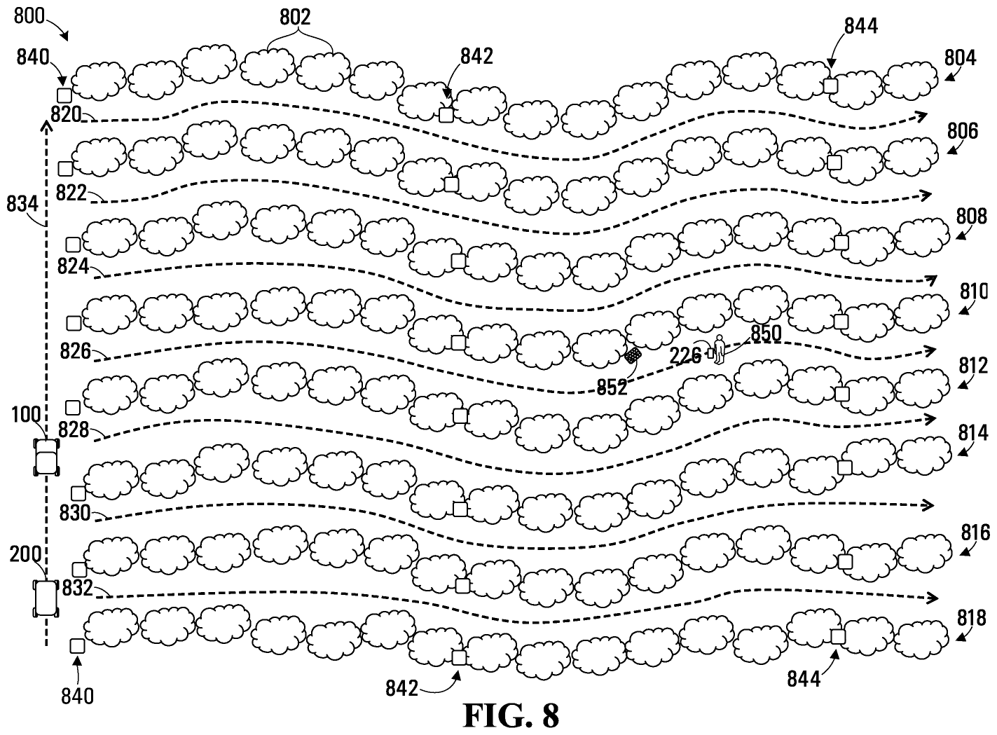

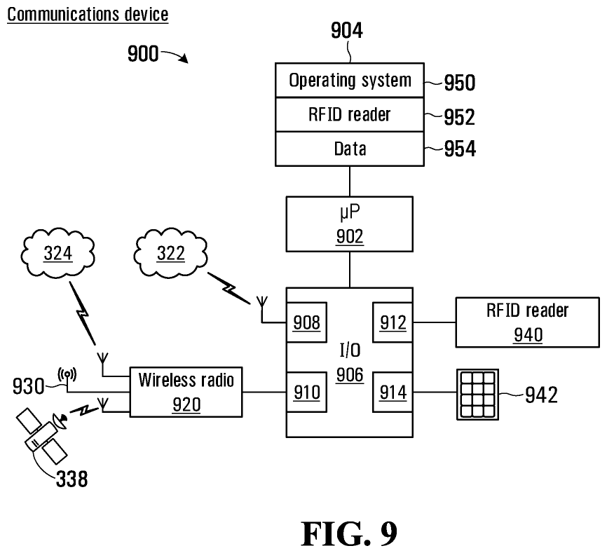

FIG. 3 is a block diagram of a processor circuit for implementing a vehicle controller of either the vehicle shown in FIG. 1 or the vehicle shown in FIG. 2;

FIG. 4 is a plan view representation of a cultivation area;

FIG. 5 is a flowchart of a pickup process executed by the controller processor circuit of FIG. 3

FIG. 6 is a block diagram of a processor circuit for implementing a host controller in the cultivation area shown in FIG. 4;

FIG. 7 is a flowchart of a process executed by the processor circuit of FIG. 6 for monitoring a plurality of robotic vehicles transporting harvested crops within the cultivation area shown in FIG. 4;

FIG. 8 is a plan view representation of an area in accordance with another disclosed embodiment;

FIG. 9 is a block diagram of a processor circuit for implementing a communications device carried by a worker in the area shown in FIG. 8;

FIG. 10 is a flowchart of a process for determining a location of a worker within the area shown in FIG. 8;

FIG. 11 is a is a plan view of a portion of the area shown in FIG. 8;

FIG. 12 is a flowchart of a process executed by the processor circuit shown in FIG. 3 for navigating either of the robotic vehicles shown in FIG. 1 or FIGS. 2 and 2A within the area shown in FIG. 8;

FIG. 13 is a simplified graphical representation of the area shown in FIG. 8; and

FIG. 14 is a look-up table stored in a memory of the processor circuit shown in FIG. 3 for navigating the vehicles shown in FIG. 1 and FIGS. 2A and 26.

### DETAILED DESCRIPTION

Referring to FIG. 1, a robotic vehicle apparatus is shown generally at 100. The vehicle 100 includes a chassis 102 having rear wheels 104 and front wheels 106 mounted on the chassis. At least one of the rear wheels 104 and front wheels 106 are driven by a vehicle drive (not shown). The front wheels 106 may be steerable and the drive may further include a steering mechanism (not shown) coupled to the front wheels. The vehicle 100 further includes a load carrying repository 108 mounted on the chassis 102. In the embodiment shown the repository 108 has an open volume 110 for receiving items 112 to be transported. In one embodiment the items 112 may be a harvested crop grown within a cultivation area. The vehicle 100 may transport the harvested crop to a post-harvesting location associated with the cultivation area. Examples of harvested crops include fruits such as blueberries, cherries, and olives, grapes, etc. In other embodiments, the items 112 may be parts or goods arranged on shelves within a warehouse, for example.

In the embodiment shown, vehicle 100 includes a lift actuator 114 coupled to the repository 108 for tilting the repository to unload items 112 from the volume 110. As an example, items 112 accumulated in the volume 110 may be discharged through a pivoting flap 116 at the rear of the repository 108 when the repository 108 is tilted upwardly as shown in FIG. 1. In other embodiments the repository 108 may be configured to be removable from the chassis 102 along with the items loaded therein. Alternatively the repository 108 may be configured as a hopper having a chute (not shown) within a base of the repository 108 that can be opened to permit the items 112 to be discharged.

In some embodiments items 112 may be initially accumulated in a container 120 and the container may be emptied into the repository 108 by a worker. In the embodiment shown, the vehicle 100 further comprises an automated loader 118 that is configured to receive a container 120 and lift the container upwardly to discharge the accumulated items 112 into the volume 110 of the repository 108. The automated loader 118 may be activated by a switch (not shown) or may be activated when the worker places the container 120 on the automated loader 118. Alternatively, the container 120 and the accumulated items 112 may be manually loaded into the repository by the worker.

The vehicle 100 also includes a vehicle controller 122 disposed on the vehicle for controlling the vehicle drive to perform drive and steering operations, vehicle navigation, and other functions. The vehicle 100 also includes a wireless communications module 124, which includes receivers and/or transceivers that may implement various wireless communications protocols for communicating over short or long ranges. For example, the wireless communications module 124 may implement radio transceivers for communicating over a cellular data network, a Wi-Fi network, or via a Bluetooth protocol. The wireless communications module 124 may also implement receive and/or transmit signals for establishing a location of the vehicle 100, such as a global positioning system (GPS) receiver or Ultra-WideBand (UWB) transceiver, for example.

The vehicle 100 further includes a plurality of sensors, including a two-dimensional light detection and ranging (LiDAR) sensor 126, one or more forward looking cameras 128, and a three-dimensional LIDAR sensor 130. The LIDAR sensors 126 and 128 provide data that can be used to identify obstacles to navigation of the vehicle 100. The 2D LIDAR sensor 126 provides information for a single plane and may be useful in quickly identifying obstacles in the path of the vehicle. The 3D LIDAR sensor 130 provides information for a plurality of planes and may provide additional information related to obstacles not detected by the LIDAR sensor 126. In the embodiment shown the vehicle 100 also includes a monitoring camera 132, disposed to monitor operations of the vehicle such as loading operations and/or a fill level of items 112 in the repository 108.

The vehicle 100 also includes one or more quantity sensors 134 located on the chassis 102 for measuring a quantity of items being carried in the repository 108. In one embodiment the sensors 134 may be implemented as a plurality of load cells disposed at points between the repository 108 and the chassis 102. The load cell sensors 134 may be calibrated to provide a relatively accurate measure of both a change in weight when a container 120 of items 112 is dumped into the repository and the total weight being carried in the repository 108. In other embodiments, the sensors 134 may be implemented as strain gauges attached to various points on the chassis 102 to produce signals representing changes in chassis strain due to the weight of items being carried in the volume 110. Strain signals can also be calibrated to provide a weight being carried in the repository 108.

The vehicle 100 also includes a radio frequency identifier (RFID) reader 136 for reading RFID transponder tags. In this embodiment the RFID reader 136 is disposed proximate the loading lift 118 for reading a container identification 138 on the container 120, such as an RFID transponder tag. RFID transponders are generally configured to transmit a signal in response to being triggered by an electromagnetic interrogation pulse from the RFID reader 136. The signal transmitted by the RFID transponder includes digital data such as an identifier. In some embodiments the container RFID transponder 138 may further facilitate localization via GPS or other positioning signals to augment information provided by the RFID transponder 138 to include location information.

Referring to FIG. 2A, a robotic vehicle apparatus in accordance with another disclosed embodiment is shown generally at 200. As described above in connection with the FIG. 1 embodiment, the vehicle 200 includes a wheeled chassis 202 and a load carrying repository 204. However in this embodiment the repository 204 includes an enclosed volume 206 (shown partially cut away in FIG. 2A) for receiving and storing items such as harvested crops that are subject to spoilage. As an example, many soft fruit crops are susceptible to heat, too much moisture, too little moisture, and contamination by airborne particulate and organisms. The enclosed volume 206 is operable to reduce exposure of the harvested crop to environmental conditions during transport to the post-harvesting location. In the embodiment shown the vehicle 200 includes an environmental control 208 operable to control at least one environmental condition within the enclosed volume 206. The environmental control 208 is in communication with the enclosed volume 206 and in the embodiment shown is disposed inside the enclosed volume. As an example, the environmental control 208 may be a humidity control or sprayer that regulates a humidity level within the enclosed volume. Alternatively or additionally the environmental control 208 may be a refrigeration system that operates to cool or regulate a temperature within the enclosed volume.

As described above for the vehicle 100, the vehicle 200 also includes a vehicle controller 212, LIDAR sensors 214 and 216, a wireless communications module 218, and a RFID reader 228. The RFID reader 228 is disposed on the vehicle 200 proximate the access port 210 to read an RFID transponder 230 associated with the container 224. The vehicle 200 may also include a quantity sensor and one or more cameras (not shown), as described above in connection with the vehicle 100.

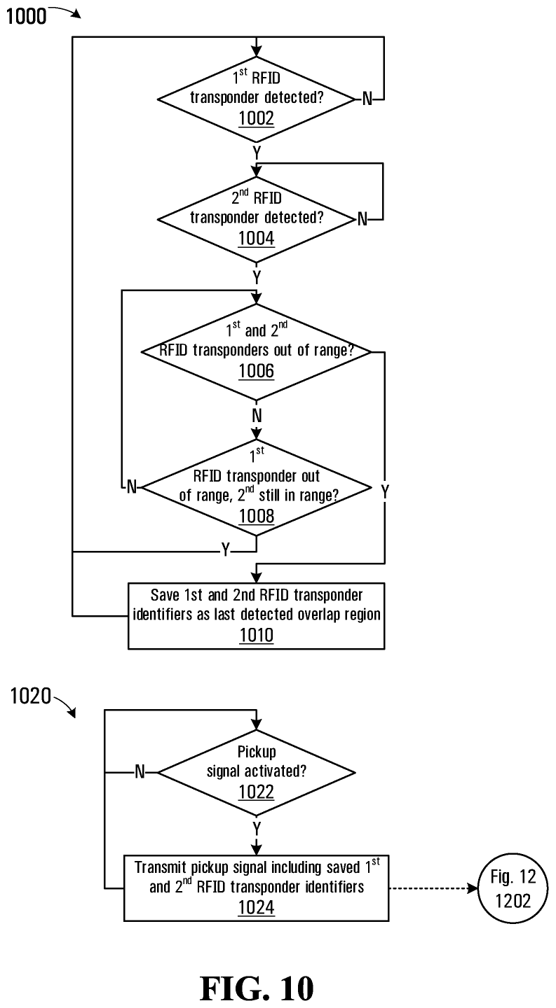

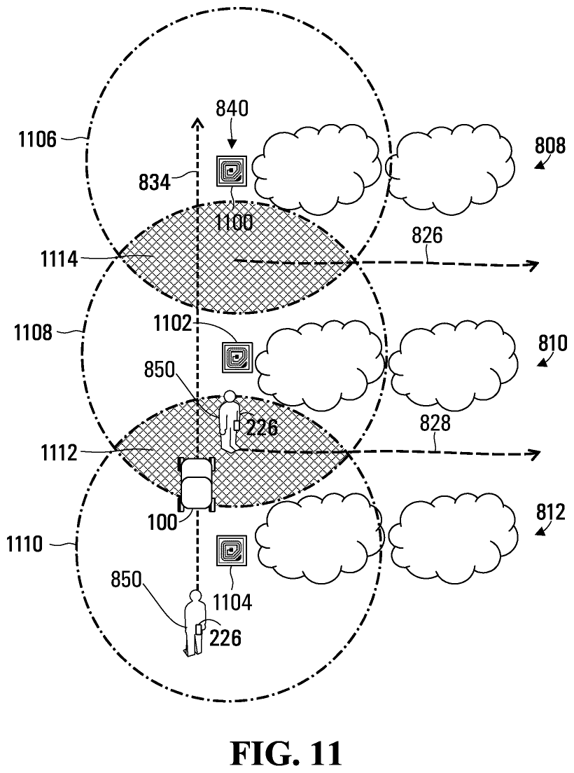

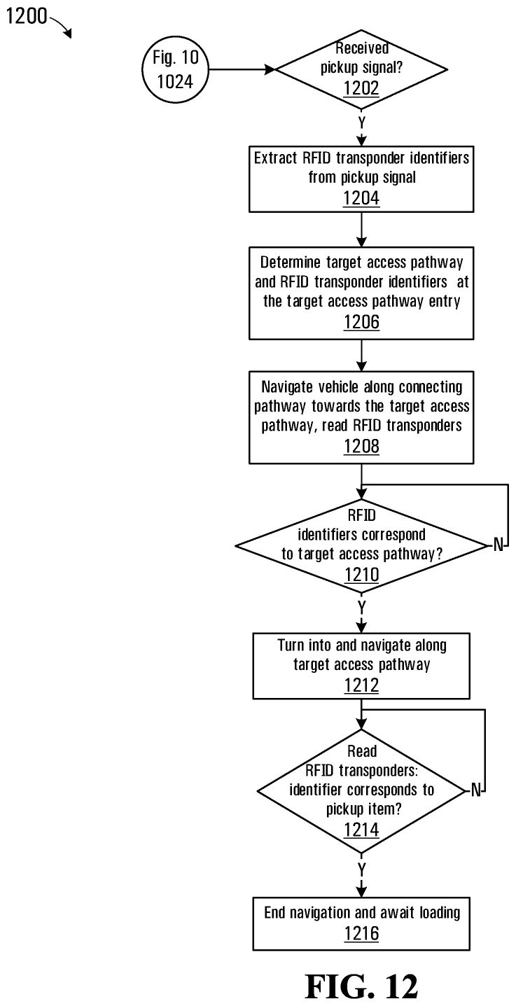

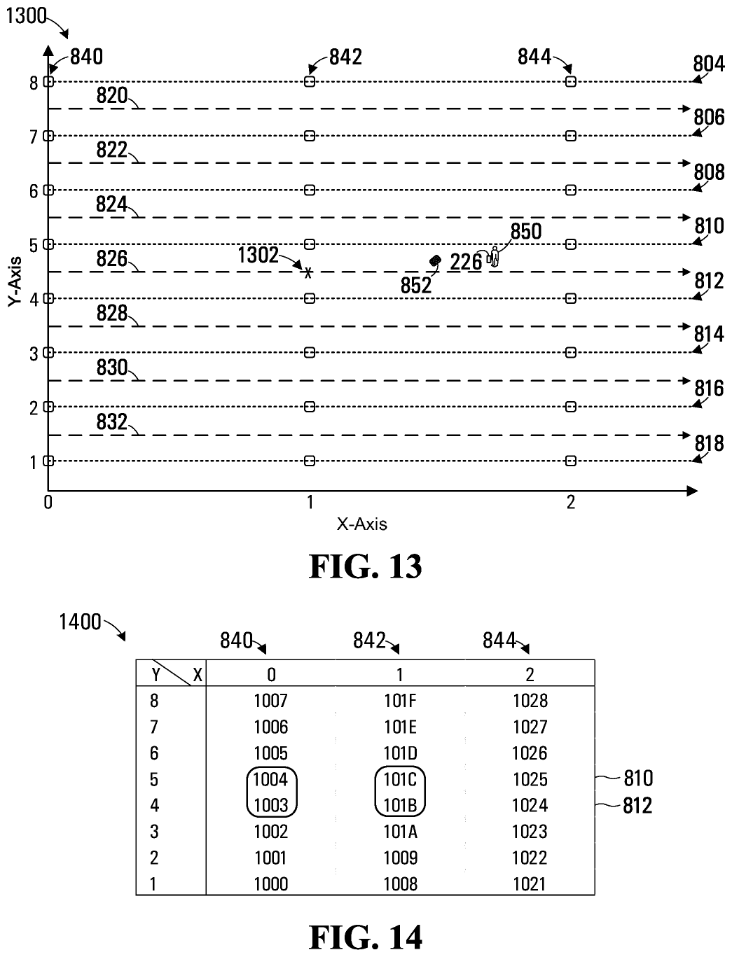

The repository 204 of the vehicle 200 is accessed via an access port 210. Referring to FIG. 26, the access port 210 is shown in an opened condition and a worker 220 is shown loading items 222 accumulated in a container 224 into the enclosed volume 206. In this embodiment the access port 210 is sized to permit the container 224 to be loaded through the access port and placed in the enclosed volume 206. Alternatively, the items 222 in the container 224 may be emptied through the access port 210 into the enclosed volume 206.

In some embodiments the access port 210 may be actuated to open automatically to provide access for loading items 222. For example, the RFID reader 228 may be configured to detect the RFID transponder 230 on the container 224 or an RFID transponder associated with the worker. Similarly, the access port 210 may be also be actuated to close automatically when the loading of items 222 has been completed. In other embodiments the access port 210 may be opened manually by the worker 220 prior to loading items into the enclosed volume 206. In the embodiment shown, the worker 220 is carrying a wireless communications device 226, the function of which will be described later herein.

Referring to FIG. 3, the vehicle controller 122 shown in FIG. 1 or the vehicle controller 212 shown in FIG. 2A may be implemented using a processor circuit shown generally at 300. The vehicle controller processor circuit 300 may be implemented using an embedded processor circuit such as a Microsoft Windows® industrial PC. The vehicle controller processor circuit 300 is further described below for implementation as either the vehicle controller 122 in the vehicle 100, or the vehicle controller 212 in the vehicle 200.

The controller processor circuit 300 includes a microprocessor 302, a computer readable medium or memory 304, and an input output (I/O) 306, all of which are in communication with the microprocessor 302. The I/O 306 includes an interface 308 (such as an IEEE 802.11 interface) for wirelessly receiving and transmitting data communication signals between the controller processor circuit 300 and a local network 322 within the cultivation area. The I/O 306 also includes an interface 310 for connecting to the wireless communications module 124 or 218 of the applicable vehicle 100 or 200. The wireless communications module 124/218 facilitates communications via a wide area data network 324. The wide area data network 324 and the local network 322 may each be in communication with a host controller 332, which in the embodiment shown as a computer server. The wireless communications module 124/218 also includes a Global Positioning System (GPS) receiver for receiving GPS positioning signals from a satellite network 328. In this embodiment, the wireless communications module 124/218 also includes one or more ultra-wide band sensors (UWB) 330 that use low energy short-range radio signals for communicating with UWB navigation beacons disposed within the workspace (not shown). The I/O 306 further includes a wired network interface 312 (such as an Ethernet interface) for connecting to the 2D LIDAR sensor 126/214 and three-dimensional LIDAR sensor 130/216.

In some embodiments the host controller 332 may be provided by one or more of the vehicle controller processor circuits 300 on the vehicles. For example, functions described herein as being provided by a host controller may be distributed between several vehicle controllers of vehicles operating in an area.

The I/O 306 further includes a USB interface 314. The forward looking camera 128 and the monitoring camera 132 are connected to the USB interface 314 for receiving and communicating image data from the respective cameras to the microprocessor 302. The USB interface 314 is also connected to the RFID reader 136/228 for receiving and processing identifiers detected by the reader. The controller processor circuit 300 further includes a digital to analog converter (DAC) 340, which is in communication with the microprocessor 302 via the USB interface 314. The DAC 340 includes ports for receiving analog signals and converting the analog signals into digital data representing the signals. The DAC 340 also includes ports for producing analog control signals in repose to data provided to the DAC. For example, the DAC 340 includes a port 342 for producing control signals for controlling the drive wheels and for moving and steering the wheeled chassis of the vehicles 100 and 200. In the example shown the DAC 340 also includes a port 344 for producing control signals for controlling the environmental control 208 of the vehicle 200, and a port 346 for controlling opening and closing of the access port 210. The DAC 340 further includes a port 348 for receiving analog quantity signals from the quantity sensors 134 and converting the analog signals into digital data representations thereof for use by the controller processor circuit 300.

Codes for directing the microprocessor 302 to carry out various operating system functions are stored in a location 350 of the memory 304, which may be implemented as a flash memory, for example. The codes 350 direct the microprocessor 302 to implement an operating system (such as Microsoft Windows for example). Program codes for directing the microprocessor 302 to perform various other system functions associated with operation of the vehicle 100 are stored in a location 352 of the memory 304. The memory 304 also includes a storage location 354 for storing navigation codes for implementing automated navigation functions on the either the vehicle 100 or the vehicle 200. A storage location 356 in the memory 304 provides for storage of data and parameters associated with operation of the program codes and operating system.

Referring to FIG. 4, a representation of a cultivation area is shown in plan view at 400. The cultivation area 400 includes a plurality of crop plants 402 being cultivated in a plurality of rows 404-410. The rows 404-410 are spaced apart sufficiently to permit the vehicle 100 and/or the vehicle 200 to navigate between adjacent rows. In this embodiment a plurality of workers 412-420 are distributed throughout the cultivation area 400 to perform manual crop harvesting. In other embodiments mechanical or other automated harvesting apparatus may replace or augment the workers 412-420. For manual harvesting, each worker 412-420 may accumulate harvested crop portions into a container 422. The cultivation area 400 also includes a post-harvesting location 430 at which the harvested crop portions are received and further processed. In some embodiments the post-harvesting location 430 may be an interim location such as a bulk transport vehicle in which a significant quantity of harvest crop may be accumulated for transport to a final post-harvesting location 432. At the final post harvesting location 432, the crop may be washed, packaged, and stored, prior to further transport to a distributor or retail outlet.

In the embodiment shown the host controller 332 is shown physically located at the cultivation area 400, but could also be remotely located and accessible via the wide area data network 324 (shown in FIG. 3). For example, the host controller 332 may be implemented as a cloud server using a service such as Amazon Web Services (AWS).

The embodiment shown also includes a plurality of UWB beacons distributed at fixed locations 440-446 within the cultivation area 400. The UWB beacons 440-446 each include transceivers that receive and/or transmit radio frequency (RF) positioning signals. Ultra-wideband transceivers use a low energy level RF pulse transmission over a wide bandwidth for short-range communications and are commonly used in precision locating and tracking applications. UWB pulses have low energy and in addition to requiring low operating power, also generally do not conflict with other wireless signals. In some embodiments, the vehicle 100 or 200 may transmit and/or receive UWB pulses to determine the location of the vehicle with respect to known locations of the UWB beacons 440-446 for determining the location of the vehicle within the cultivation area 400.

Referring to FIG. 5, a flowchart of a pickup process executed by the controller processor circuit 300 of the vehicle 100 is shown generally at 500. The blocks of the process 500 generally represent codes that may be read from the program code location 350 in the memory 304 for directing the microprocessor 302 to perform functions related to transporting the harvested crop within a cultivation area 400. The actual code to implement each block may be written in any suitable program language, such as C, C++, C #, Java, and/or assembly code, for example.

Block 502 directs the microprocessor 302 to determine whether a pickup signal has been received at the interface 310 via the wireless communications module 124/218. In this embodiment, the pickup signal indicates that a harvested crop portion is available for transport to the post-harvesting location 430 and also identifies a location of one of the workers 412-420 within the cultivation area.

In an embodiment where the workers 412-418 each carry a wireless communications device, such as the wireless communications device shown at 226 in FIG. 26, the pickup signal may be initiated by the worker activating the device to transmit the pickup signal. The device 226 is configured to transmit the pickup signal including the current location of the worker within the cultivation area 400. In some embodiments the wireless communications device 226 may be capable of determining geographic location information representative of the location of the worker and the pickup signal may include this information. The location information may be based on receiving GPS signals from the satellite network 328. In other embodiments the location information may be based UWB signals transmitted and/or received from the navigation beacons 440-446 within the cultivated area 400. The pickup location may be referenced to a coordinate frame 448 (shown in FIG. 4), which may be either a local or geographic coordinate frame.

The pickup signal transmitted by the wireless communications device 226 may be received directly by the wireless communications module 124/218 of the applicable vehicle 100 or 200. Alternatively the pickup signal may be received at the host controller 332 and relayed to the vehicle controller 122/212 via the local network 322 or other communications link established between the host controller and the wireless communications module 124/218. In some embodiments the host controller 332 may maintain a record of several vehicles 100 or 200 in the cultivation area 400 and may determine which one of the vehicles is best located to make the pickup. The assignment of a particular vehicle 100 or 200 may be made based on factors such as current location, remaining load capacity, and/or a remaining capacity of an energy source associated with the vehicle.

The process 500 then continues at block 504, which directs the microprocessor 302 to read the pickup location included in the pickup signal. In embodiments where the coordinate frame 448 is a global coordinate frame, the pickup location may be expressed in the form of geographic coordinates (latitude and longitude). Alternatively, the pickup location may be defined with respect to a local coordinate frame 448 that is defined only locally within the cultivation area 400.

Block 506 then directs the microprocessor 302 to navigate the vehicle to the pickup location using navigation functions implemented by executing the navigation codes in the storage location 352 of the memory 304. In one embodiment the controller processor circuit 300 may implement a Simultaneous Localization and Mapping (SLAM) algorithm for providing automated navigation functions. Various open source SLAM code libraries are available and may be configured to use data from sensors such as the LIDAR sensors 126 and 130 or 214 and 216 while navigating within the cultivated area. Prior known information, such as locations of the rows 404-410 may be provided as an initial map input to the SLAM algorithm, which simplifies the computational problem of navigating the vehicle 100 or 200 around obstacles such as other workers, containers, or other vehicles within the rows. The SLAM algorithm may generate and update the map using the LIDAR sensors 126 and 130 and other sensors.

For the example of a pickup signal being received from the worker 416 in FIG. 4, the vehicle 100 would thus navigate between the rows 406 and 408 to the location of the worker defined in the pickup signal. While navigating, block 506 directs the microprocessor 302 to produce wheel drive and steering signals at the port 342 of the DAC 340 for controlling the direction and speed of the vehicle while avoiding obstacles such as other workers or crop containers. Navigation of the vehicle 100 continues at block 506 until the vehicle 100 reaches or is proximate the pickup location. In one embodiment, when arriving at a location proximate the location of the worker provided by the pickup signal, the microprocessor 302 is directed by block 506 to cause the RFID reader 136/228 to attempt to locate RFID transponders in range. In some embodiments where RFID transponder signals of a worker or a container are detected, the vehicle may navigate closer to the source of the signal. Block 506 then directs the microprocessor 302 to block 508. Block 508 directs the microprocessor 302 to receive a harvested crop portion 422 in the repository 108/204 of the vehicle 100 or 200. In the case of the vehicle 200, block 508 further directs the microprocessor 302 to open the access port 210 by producing a signal at the port 346 of the DAC 340.

Block 510 of the process 500 then directs the microprocessor 302 to generate an identifier attributing the received harvested crop portion 422 with the worker 416. In embodiments where the pickup signal is transmitted by the worker 416, the pickup signal may already include information identifying the worker. In other embodiments, the worker may carry a worker identification, such as an RFID transponder, which may be read by the RFID reader 136/228 when the worker is proximate the vehicle.

In other embodiments, each container 120 may have an RFID transponder identifier of the RFID transponder 138 on the container associated with a particular worker. In this embodiment, when the RFID transponder 138 of the container is detected by the RFID reader 136/228 on the vehicle 100 or 200, the harvested crop portion in the container may be attributed to the associated worker. As an example, the association between container identifiers and workers may be made in the host controller 332 when the worker receives a set of containers for harvesting operations prior to beginning work in the cultivation area 400. Alternatively, the wireless communications device 226 carried by the worker may be configured to produce a RFID response signal that transmits the worker identification to the RFID reader 136/228 or the communications module 124/218 associated with the vehicle 100 or 200.

The process 500 then continues at block 512, which directs the microprocessor 302 to determine the quantity of the received harvested crop portion 422. In embodiments that implement load cell sensors 134, block 512 directs the microprocessor 302 to receive signals from the load cell sensors 134 after receiving the harvested crop portion 422. The weight of the harvested crop portion loaded may be determined by subtracting a previously determined total weight of harvested crops carried in the repository 108/204 prior to loading the crop portion 422 harvested by the worker 416. In other embodiments the quantity of the received harvested crop portion 422 may be determined or estimated by other methods. For example, an image of the harvested crop portion 422 may be captured by the monitoring camera 132 of the vehicle 100 during loading and the image processed by the microprocessor 302 to estimate a quantity, for example by counting a number of items loaded.

Block 514 of the process 500 then directs the microprocessor 302 to transmit quantity data to the host controller 332. The quantity data includes at least the quantity of the harvested crop portion 422 and the identifier attributing the harvested crop portion to the worker 416. The process 500 continues at block 516, which directs the microprocessor 516 to determine whether the total quantity of harvested crop being carried in the repository 108/204 meets a criterion. As an example, the vehicle 100 or 200 may have a maximum load carrying capacity. If at block 516 it is determined that the capacity has been reached, block 516 may direct the microprocessor 302 to block 518. Block 518 then directs the microprocessor 302 to cause the vehicle 100 or 200 to return to the post-harvesting location 430 to unload the vehicle. The microprocessor 302 is thus directed to again execute the navigation codes in the location 352 of the microprocessor 302, this time with the navigation target being the location of the post-harvesting location 430.

If at block 516 it is determined that the capacity has not yet been reached, the microprocessor 302 may be directed to return to block 502 to await receipt of a further pickup signal from another worker. The vehicle 100 may thus remain at the pickup location or be navigated to some other location while awaiting the next pickup signal. Alternatively, the vehicle 100 or 200 may navigate to another location that has easy access to the rows 404-410.

The host controller 332 shown in FIG. 3 and FIG. 4 may be implemented using a processor circuit shown generally at 600 in FIG. 6. Referring to FIG. 6, the host controller processor circuit 600 includes a microprocessor 602, a computer readable medium and/or memory 604, and an input output (I/O) 606, all of which are in communication with the microprocessor 602. The I/O 606 includes a wired network interface 610 (such as an Ethernet interface) for connecting to the wide area data network 324. In this embodiment the I/O 606 also includes a wired network interface 612 for connecting to at least one wireless network access point 620. The access point 620, or a plurality of the access points 620, may be distributed and configured to establish a Wi-Fi network within the cultivation area 400 that is accessible by the vehicles 100 and 200 and/or the workers 412-420 via wireless communication devices. The UWB beacons 440-444 may also connect to the controller processor circuit 300 via the access point 620 for configuring the access point. The I/O 606 further includes an interface 614 for connecting to a management database 622. The management database 622 may be configured to accumulate and store details of quantities harvested by the various workers. The management database 622 may be hosted on the processor circuit 600 or may be implemented as a remote database that runs on a separate processor circuit, which may be a remote processor circuit.

Codes for directing the microprocessor 602 to carry out various operating system functions are stored in a location 650 of the memory 604, which may be implemented as a flash memory, for example. The codes 650 direct the microprocessor 600 to implement a server operating system (such as Microsoft Windows Server for example). Program codes for directing the microprocessor 602 to perform various other system and database functions associated with operation of the vehicle 100 are stored in a location 652 of the memory 604. The location 654 provides for storage of data and parameters associated with operation of the program codes and operating system. The memory 604 also includes a storage location 656 for storing layout data associated with the area 800.

Referring to FIG. 7, a process executed by the host controller processor circuit 600 for monitoring a plurality of robotic vehicles transporting harvested crops within the cultivation area 400 is shown generally at 700. The process 700 starts at block 702, which directs the microprocessor 602 to determine whether quantity data has been received from a vehicle controller 122/212 of one of vehicles 100 or 200. As disclosed above, the quantity data would include a quantity of harvested crop portion and an identifier attributing the harvested crop portion to one of the workers 412-420 within the cultivation area 400. In one embodiment, the quantity data may be received at the access point 620 as a Wi-Fi signal transmitted by the wireless communications module 124 or 218 of the respective vehicles 100 or 200. Alternatively, the wireless communications modules 124 or 218 may upload signals via a cellular or other data network to the wide area data network 324, and the quantity data may be received via the wired network interface 610.

If no quantity data is received, block 702 is repeated. If at block 702, quantity data is received, the microprocessor 602 is directed to block 704. Block 704 directs the microprocessor 602 to read the quantity data to determine the worker identifier. Block 704 further directs the microprocessor 302 to access a worker record for the identified worker in the management database 622. Block 706 then directs the microprocessor 602 to read the harvested crop quantity value in the quantity data and to store the crop quantity value in the worker record. Block 706 then directs the microprocessor 602 back to block 702 to read and process the next quantity data signal received from one of the vehicles 100 or 200.

Still referring to FIG. 7, a management function process executed by the host controller processor circuit 600 is shown generally at 720. The management function process starts at block 722, which directs the microprocessor 602 to determine whether the management function has been invoked. If the management function has been invoked, block 722 directs the microprocessor 602 to block 724. Block 724 directs the microprocessor 602 to receive input of a worker identifier or a plurality of worker identifiers to be processed. Block 726 then directs the microprocessor 602 to query the database records for the identified worker(s) and to calculate the total harvested crop quantity attributed to the worker. Block 724 thus directs the microprocessor 302 to read quantity values and to total up the total harvested crop quantity that has been attributed to the worker. Block 728 then directs the microprocessor 602 to calculate a wage payment that is due to the worker based on the total harvested crop quantity and a previously established payment rate. Block 728 then directs the microprocessor 602 back to block 722.

In other embodiments, other management processes may be implemented to calculate metrics associated with the identified worker. For example, in the worker record stored in the management database 622, each quantity value written to the database may be associated with a pickup time. In one example, the pickup times may be analysed to calculate worker efficiency metrics for comparing the effectiveness of different workers. Management processes may additionally be configured to cause additional information such as the location of the worker, and/or an elapsed time at the location by the worker between transmitting pickup signals. The process may involve analysing the gathered data to extract patterns from the information, which may be provided a productivity report or other form. In other embodiments, the gathered information may be used by the management function process 720 to estimate a period of time that the worker will take to make the harvested crop portion available for transport. In some embodiments the pickup signal may be initiated by the host controller based on the estimated period of time.

Additionally, the management processes may be configured to gather information such as starting and ending locations of the vehicles 100 or 200, routes travelled by the vehicles between the starting and ending locations, time spent travelling, and energy consumed by the vehicles. Based on this gathered information, the management processes may detect a pattern in the gathered information, and determine routes for the vehicles based on the detected pattern to minimize parameters such as travel time, energy consumption, or distance travelled by the vehicles. In other embodiments, the vehicle controllers 122 and 212 of the vehicles 100 and 200 operating in the cultivation area 400 may be configured to communicate between each other to exchange operating information such as a current pickup task and/or location. The information may be utilized by the vehicle controllers 122 and 212 to prevent right of way issues etc. that may cause delayed pickup.

Referring to FIG. 8, a representation of an area in accordance with another disclosed embodiment is shown in plan view at 800. The area 800 shown in FIG. 8 is a cultivation area having a plurality of crop plants 802 arranged in plurality of generally longitudinally extending adjacent rows 804-818. However, in other embodiments, the area 800 may have any items arranged in adjacent rows, such as items on shelving in a warehouse, for example.

The area 800 includes access pathways 820-832 (shown in broken lines) interposed between each of the adjacent rows 804-818. The access pathways 820-832 are sized to permit the vehicles 100 or 200 to navigate along the pathways between the respective adjacent rows. The area 800 also has a connecting pathway 834 connecting between the access pathways 820-832. The area 800 also includes a RFID transponder tag disposed proximate an end of each row 804-818, proximate the connecting pathway 834. Each RFID transponder is a member of a first plurality of fixed location RFID transponders 840 and is uniquely identifiable within the area 800, for example by a unique identifier assigned to the transponder.

In the embodiment shown a second and third plurality of fixed location RFID transponders 842 and 844 are disposed along the rows 805-818 inwardly from the first plurality of fixed location RFID transponders 840. Each one of the transponders in the second and third plurality of RFID transponders 842 and 844 is disposed within the respective row. In other embodiments further pluralities of fixed location RFID transponders may be placed along the rows 805-818. In some embodiments the RFID transponders 840, 842 and 844 may be implemented using passive RFID transponders that are powered by Radio Frequency energy transmitted from the RFID readers 136 and 128 when scanning for RFID transponders. Alternatively, actively powered tags may be employed to extend a range within which the transponder is readable by one of the RFID readers 136 or 128.

In one embodiment, the wireless communications device 226 carried by the worker 220 shown in FIG. 2 may be implemented using a device such as a smartphone or other digital communications device. Referring to FIG. 9, an embodiment of a communications device processor circuit of the wireless communications device is shown generally at 900. The communications device processor circuit 900 includes a microprocessor 902, a computer readable medium or memory 904, and an input output (I/O) 906, all of which are in communication with the microprocessor 902. The I/O 906 includes an interface 908 (such as an IEEE 802.11 interface) for wirelessly receiving and transmitting data communication signals between the controller processor circuit 900 and the local network 322 within the cultivation area 800. In some embodiments the processor circuit 900 includes a wireless radio 920 that facilitates communications via a wide area data network 324 and the I/O 906 further includes an interface 910 for connecting to the wireless radio. The wireless radio 920 also includes a Global Positioning System (GPS) receiver for receiving GPS positioning signals from the satellite network 328. The wireless radio 920 may also include one or more ultra-wide band sensors (UWB) 930 for communicating with UWB navigation beacons. In this embodiment the processor circuit 900 also includes an RFID reader 940 and the I/O 906 further includes an interface 912 for connecting to the RFID reader. The communications device processor circuit 900 further includes a user input device such as a keypad or touchscreen implemented user interface 942, which is connected to the microprocessor 902 via an interface 914.

Codes for directing the microprocessor 900 to carry out various operating system functions are stored in a location 950 of the memory 904, which may be implemented as a flash memory, for example. The codes 950 direct the microprocessor 900 to implement an operating system (such as the Apple iOS or Android operating system). Program codes for directing the microprocessor 902 to perform RFID reading functions using the RFID reader 940 are stored in a location 952 of the memory 904. A storage location 954 in the memory 904 provides for storage of data and parameters associated with operation of the program codes and operating system.

Referring to FIG. 10, a process for determining a location of a worker within the area 800 is shown generally at 1000. The process 1000 may be run continuously on the communications device processor circuit 900 in response to the RFID codes 952 being executed to cause the RFID reader 940 to be activated for detecting RFID transponders. The process 1000 begins at block 1002, which directs the microprocessor 902 to determine whether a first RFID transponder has been detected. Referring to FIG. 11, a portion of rows 808, 810, and 812, access pathways 826 and 828, and the connecting pathway 834 are shown in enlarged view. A RFID transponder 1100 of the plurality of RFID transponders 840 is disposed at the end of the row 808, a RFID transponder 1102 is disposed at the end of the row 810, and a RFID transponder 1104 is disposed at the end of the row 812. Each RFID transponder 1100-1104, when interrogated by an RFID reader transmits an identification signal. The signal will be readable within a reception range indicated in FIG. 11 as the circle 1106 for the RFID transponder 1100, the circle 1108 for the RFID transponder 1102, and the circle 1110 for the RFID transponder 1104. When the worker 850 initially enters the reception range 1110, the RFID reader 940 of the communications device processor circuit 900 will detect and read the identifier transmitted by the RFID transponder 1104. When the RFID transponder 1104 is detected, block 1002 directs the microprocessor 902 to block 1004. If at block 1002 an RFID transponder is not detected, the microprocessor 902 is directed to repeat block 1002.

Block 1004 then directs the microprocessor 902 to determine whether a second RFID transponder has been detected. When the worker 850 moves to the location shown at 850′ within the reception range 1108, the RFID reader 940 will also detect the RFID transponder 1102. In this embodiment, the plurality of RFID transponders 840 are selected and/or configured such that adjacent RFID transponders have a reception range overlap. An overlap region between the reception ranges 1108 and 1110 associated with the RFID transponders 1102 and 1104 is shown as the hatched area 1112 in FIG. 9. Each adjacent pair of RFID transponders in the plurality of RFID transponders 840 will have a similar overlap region, such as the hatched area 1114 associated with the RFID transponders 1100 and 1102. When the worker is within the overlap region 1112, the RFID reader 940 will be able to simultaneously detect signals transmitted by the RFID transponder 1104 and the RFID transponder 1102. If at block 1004 a second RFID transponder is not detected, the microprocessor 902 is directed to repeat block 1004. If at block 1004 a second RFID transponder is detected, the microprocessor 902 is directed to block 1006.

Block 1006 directs the microprocessor 902 to determine whether both the first RFID transponder 1104 and the second RFID transponder 1102 are now out of range. Under these conditions, it can be presumed that the worker is about to enter the access pathway 828 and as the worker moves along the pathway the wireless communications device 226 would move outside the overlap region 1112 and both of the reception ranges 1108 and 1110. Thus, as the worker 850 moves along the access pathway 828 away from the connecting pathway 834, eventually no RFID transponder signals would be detected. When this condition occurs at block 1006, the microprocessor 902 is directed to block 1010.

Block 1010 directs the microprocessor 902 to save information identifying the last two RFID transponder tags that have been simultaneously read, i.e. the transponders 1102 and 1104. If at block 1006, the microprocessor 902 determines that the condition of the first RFID transponder 1104 and the second RFID transponder 1102 both being out of range is not met, the microprocessor is directed to block 1008. Block 1008 directs the microprocessor 902 to determine whether the first RFID transponder 1104 is out of range while the second RFID transponder 1102 is still in range. This condition corresponds to the worker 850 continuing to move along the connecting pathway 834 (i.e. the worker has not entered the access pathway 828). If this condition is not met, the worker is assumed to remain in the overlap region 1112 and block 1008 directs the microprocessor 902 to repeat block 1006. If the condition at block 1008 is met, the microprocessor 902 is directed back to block 1002 and the process repeats for the next pair of adjacent RFID transponders 1102 and 1100 as the worker moves up the connecting pathway 834. The process 1000 is executed by the microprocessor 902 continuously while the worker 850 is in the area 800.

In other embodiments where harvesting is done by automated harvesting equipment, the RFID reader may be associated with the harvesting equipment rather than the worker 850. The process 1000 remains essentially the same whether harvesting is manually performed by workers or by automated harvesting equipment.

Still referring to FIG. 10, a process executed by the communications device processor circuit 900 for transmitting a pickup signal is shown generally at 1020. The process 1020 may also be run continuously on communications device in response to the RFID codes 952 being executed. The process 1020 begins at block 1022, when the worker 850 activates a pickup signal transmission function on the wireless communications device 226. The worker 850 may activate the function by providing user input at the keypad or touchscreen implemented user interface 942 to indicate that a container 852 is available for pickup. The container 852 may include a container RFID transponder, such as shown for the container 120 having an RFID transponder 138 attached. If at block 1022, the user has activated the pickup signal transmission function, the microprocessor 902 is directed to block 1024, which directs the microprocessor to transmit a pickup signal including the identifiers last saved for the first and second RFID transponder tags that were saved at block 1010 of the process 1000. In the example shown in FIG. 11, the last detected transponders 1102 and 1104 would thus identify the target access row that the worker 850 has most recently entered. If there are no last saved identifiers, then the worker 850 can be assumed to still be on the connecting pathway 834.

In embodiments where the area 800 includes the second and/or third plurality of RFID transponders 842 and 844, the above process may be repeated as the worker 850 passes through an overlap region between RFID transponders disposed in adjacent rows. The wireless communications device 226 would then save information identifying these RFID transponders as the last two RFID transponder tags that had been simultaneously read. When the worker 850 initiates a pickup signal, the transmitted signal would include the identifiers of the last detected transponders 1102 and 1104, thus further providing a more recent location of the worker 850 along access pathway 828.

If the plurality of crop plants 802 in the area 800 have sufficient space between plants to allow the worker to move off the access pathway 828 to either the access pathway 826 or 830, the information identifying the last detected transponders would become invalid. This condition would not arise if the layout of the area prevents movement between rows except at the connecting pathway 834. The condition of invalidity may be prevented by instructing the workers to only move between rows at the location of the first, second, or third plurality of RFID transponders 840, 842, or 844. As described above in connection with FIG. 10, movement between rows and between associated overlap regions is detectable and results in the last detected transponder indications being updated to reflect the new access pathway.

Referring to FIG. 12, a process executed by the vehicle controller processor circuit 300 shown in FIG. 3 for navigating either of the robotic vehicles 100 or 200 within the area 800 is shown generally at 1200. The navigation process 1000 begins at block 1202, which directs the microprocessor 302 of the vehicle controller processor circuit 300 to determine whether a pickup signal has been received at the vehicle controller. The pickup signal may have been transmitted by the worker 850 at block 1024 of the process 1020, and in this embodiment identifies a pair of RFID transponders that have an overlap region through which the worker last moved. Block 1204 then directs the microprocessor 902 to extract the RFID transponder identifiers in the pickup signal.

Referring to FIG. 13, in one embodiment the area 800 may be represented as a simplified graphical representation 1300, in which the connecting pathway 834 is located along the Y-Axis and the X-Axis is oriented in the direction of the rows 804-818 and access pathways 820-832. In the simplified graphical representation 1300, the rows 804-818 and access pathways 820-832 are represented as straight and regularly spaced lines aligned with the X-Axis. While this could be an accurate representation for some areas such as a warehouse, in most cases a cultivation area such as shown at 800 in FIG. 8 would likely have rows and pathways that deviate from straight and regular lines. In the simplified graphical representation 1300, the pluralities of RFID transponders 840, 842, and 844 are aligned along the respective rows 804-812 and may be defined in terms of by X and Y coordinates on the graph 1300. Each RFID transponder may thus be uniquely identified by a coordinate pair (X,Y).

In one embodiment, the simplified graphical representation 1300 may be stored in the area layout data storage location 656 of the memory 304 in the form of a look-up table. An example of a suitable look-up table is shown in FIG. 14 at 1400. The rows 804-818 may be represented as a Y-Axis series of numbers 1-8, in which the order is reversed to correspond to the simplified graphical representation 1300. The first, second and third pluralities of fixed location RFID transponders 840, 842, and 844 are represented as columns 0, 1 and 2 in the look-up table 1400. At each X,Y coordinate in the look-up table 1400, the identifier of the RFID transponder at that location is loaded into the table. In this example, the RFID transponder identifier is a 4 byte number (i.e. 4 bits×4=32 bits), and the RFID transponders are numbered sequentially starting at 1000 hex. The simplified order of RFID transponder identifiers is used for sake of illustration and in practice, the RFID transponder identifier may have more or less than 4 bytes and the numbering need not be sequential as long as the identifiers are correctly loaded into the memory storage location 656.

The process 1200 then continues at block 1206, which directs the microprocessor 302 to determine the target access pathway by looking up a corresponding access row in the look-up table 1400. For example if the two RFID transponder identifiers extracted from the pickup signal at block 1204 were “101C” and “101B”, the microprocessor 302 would locate the matching pair of identifiers along the Y-Axis at Y=4 and Y=5, and along the X-Axis at X=1. This corresponds to the access pathway 826 located between the rows 810 and 812 and an X-Axis location 1302 corresponding to the second plurality of RFID transponders 842 along the row. Block 1206 of the process 1200 also directs the microprocessor 302 to look up the pair of RFID transponder identifiers associated with the first plurality RFID transponders 840 at the end of the rows 810 and 812 i.e. “1004” and “1003” in this case.

Block 1208 then directs the microprocessor 302 to navigate the vehicle along the connecting pathway toward the target access pathway 826. In one embodiment, the microprocessor 302 may maintain a data record of the last two pairs of RFID transponder identifiers encountered by the vehicle while moving along the connecting pathway in the storage location 356 of the memory 304. Block 1208 directs the microprocessor 302 to interpret this recorded data to determine a current direction of travel of the vehicle and also a required direction of travel to reach the target access pathway. Block 1208 then directs the microprocessor 302 to begin navigation along the connecting pathway in the determined direction of travel, while reading RFID transponders that come in range of the vehicle RFID reader.

Block 1210 then directs the microprocessor 302 to determine whether the pair of RFID transponder identifiers match the RFID transponders at the end of the rows 810 and 812 (i.e. “1004” and “1003” in this case). Block 1210 thus directs the microprocessor 302 to perform a similar process as set out in detail in blocks 1002-1008 of the process 1000 implemented on the wireless communications device 226 of the worker. As in the process 1000, when two RFID transponders are simultaneously in range in the overlap region 1114 (shown in FIG. 11), the microprocessor 302 is directed to read the respective identifiers and compare these against the pair of RFID transponder identifiers associated with the access pathway entry. If at block 1210, no match is found then the microprocessor 302 is directed to repeat block 1210. When at block 1210, a match is found then the vehicle is located on the connecting pathway alongside the entry to the access pathway (i.e. access pathway 826 in this case). Block 1212 then directs the microprocessor 302 to cause the vehicle to turn into the access pathway 826 and to continue navigation along the access pathway 826.

At this point, the pickup location provided by the worker 850 is known to be somewhere along the access pathway 826. However, in this described example, while the pickup signal transmitted by the worker 850 identified the last pair of RFID transponders as belonging to the second plurality of RFID transponders 842, it is only possible to determine that the worker is somewhere between the first plurality of RFID transponders 840 and the third plurality of RFID transponders 844. For example, even if the pickup signal includes the last detected RFID transponder pair as being members of the second plurality of RFID transponders 842, it is not clear whether the worker 850 is to the left or the right of the X-Axis location 1302.

The process 1200 then continues at block 1214, which directs the microprocessor 302 to continue to read RFID transponder signals in range of the vehicle RFID reader and to determine whether any detected RFID transponder signals corresponding to a target RFID transponder on the container 852 for pickup at the pickup location on the pathway. If a detected RFID transponder is not one of the plurality of fixed location RFID transponders 840, 842, or 844, this is indicative that the vehicle has reached a pickup location. In other embodiments, a target RFID transponder may be associated with an item to be picked up that is not in a container, a worker that initiated the pickup signal, or a communications device of worker that initiated the pickup signal.

If at block 1214, no RFID signals are detected, the microprocessor 302 is directed to repeat block 1214. In this embodiment, the container RFID transponder 138 will generally have an identifier that is distinguishable from the identifiers associated with the pluralities of fixed location RFID transponders 840, 842, and 844. For example, the identifier may have a value outside of a range of values used for the fixed location RFID transponders 840, 842, and 844. Alternatively, container RFID identifiers may be loaded into a data location in the memory 304 for comparison against detected identifiers. If at block 1214, an RFID signal is detected, the microprocessor 302 is directed to determine whether the signal corresponds to a pickup item or container, in which case the microprocessor is directed to block 1216. Block 1216 directs the microprocessor 302 to stop navigation and await loading of the container 852.

In some instances, when RFID transponder signals are detected in an overlap region for the second and plurality of RFID transponders 842, it may be assumed that the worker 850 has progressed along the access pathway 826 past the X-Axis location 1302. However, if the worker 850 instead turns back at the X-Axis location 1302, the pickup location may be missed. Additionally, if members of the third plurality of RFID transponders 844 are encountered, the microprocessor 302 would be able to determine that the pickup location has been missed and may cause the vehicle to turn around.

The navigation of the vehicles 100 or 200 in accordance with the embodiments described in FIGS. 8-14 has the advantage on not requiring the use of GPS or other navigation or location data. Rather the described embodiments rely on the use of relatively inexpensive RFID transponders for locating both the worker 850 and the pickup location within the area 800. The described embodiments also have the advantage of facilitating movement of the vehicle to the pickup location defined by the worker, where the pickup location may not be accurately determinable. The locations of the worker 850 and the container 852 may only be approximately communicated in the pickup signal, and the process 1200 may account for this by detecting the container 852.

While specific embodiments have been described and illustrated, such embodiments should be considered illustrative only and not as limiting the disclosed embodiments as construed in accordance with the accompanying claims.

1. A robotic vehicle apparatus for transporting a harvested crop within a cultivation area, the vehicle comprising:
a vehicle controller disposed on the vehicle and operably configured to:
receive a pickup signal indicating that a harvested crop portion is available for transport to a post-harvesting location, the pickup signal identifying a location of a worker within the cultivation area;
automatically navigate the vehicle to the location of the worker for loading the harvested crop portion into a load carrying repository of the vehicle;
generate an identifier attributing the harvested crop portion to the worker;
a quantity sensor operable to produce a quantity signal representative of a quantity of the harvested crop portion loaded into the repository, the vehicle controller being operably configured to receive the quantity signal and to transmit quantity data to a host controller, the quantity data including the quantity of the harvested crop portion and the identifier attributing the harvested crop portion to the worker; and
wherein the vehicle controller is further operably configured to cause the robotic vehicle to return to the post-harvesting location for unloading the harvested crop portion.

2. The apparatus of claim 1 further comprising a reader disposed on the vehicle and in communication with the vehicle controller, the reader being operable to generate the identifier attributing the harvested crop portion to the worker by reading at least one of:
a worker identification carried by the worker; and
a container identification associated with a container in which the harvested crop portion has been accumulated.

3. The apparatus of claim 2 wherein the reader comprises a radio frequency identifier (RFID) reader and at least one of the worker identification and the container identification comprises an RFID transponder.

4. The apparatus of claim 3 wherein, in response to arriving at a location proximate the location of the worker provided by the pickup signal, the vehicle controller is operably configured to cause the reader to attempt to locate RFID transponders in range and to navigate to the location of the RFID transponder.

5. The apparatus of claim 2 wherein the harvested crop portion is accumulated in a container placed by the worker at the identified location of the worker in the pickup signal, the vehicle controller being operably configured to:
at a location proximate to the location of the worker, monitor the reader to determine proximity to the container; and
maneuver the vehicle to position the vehicle for loading the container.

6. The apparatus of claim 5 wherein the vehicle further comprises an automated loader operable to grasp the container for loading the harvested crop portion into the load carrying repository of the vehicle when the vehicle is positioned for loading the container.

7. The apparatus of claim 1 further comprising a radio frequency identifier (RFID) reader disposed on the vehicle and in communication with the vehicle controller, and wherein a plurality of RFID transponders are distributed within the cultivated area, and wherein the vehicle controller is further operably configured to detect when one of the plurality of RFID transponders is within range of the reader for use in navigating the vehicle to the location of the worker.

8. The apparatus of claim 7 wherein the vehicle comprises at least one navigation sensor in communication with the vehicle controller and wherein the vehicle controller is operably configured to navigate the vehicle when outside the range of any of the plurality of RFID transponders.

9. The apparatus of claim 1 wherein the pickup signal is initiated by the worker activating a wireless communications device, the wireless communications device being operably configured to transmit the pickup signal to at least one of the host controller and the vehicle controller.

10. The apparatus of claim 9 wherein the wireless communications device is operably configured to determine geographic location information representative of the location of the worker and wherein the pickup signal includes the geographic location information.

11. The apparatus of claim 9 wherein the pickup signal is transmitted by the wireless communications device to one of:
a receiver in communication with the host controller, the host controller being configured to relay the pickup signal to the vehicle controller; and
a receiver disposed on the vehicle, the receiver being in communication with the vehicle controller.

12. The apparatus of claim 1 wherein the pickup signal is initiated by the host controller based on an estimated period of time that the worker will take to make the harvested crop portion available for transport.

13. The apparatus of claim 1 wherein the load carrying repository comprises an enclosed volume for receiving and storing harvested crop portions, the enclosed volume being operable to reduce exposure of the harvested crop to environmental conditions during transport to the post-harvesting location.

14. The apparatus of claim 13 further comprising an environmental control disposed in communication with the enclosed volume, the environmental control being operable to control at least one environmental condition within the enclosed volume.

15. The apparatus of claim 14 wherein the environmental control comprises at least one of:
a humidity control, operably configured to regulate a humidity level within the enclosed volume;
a sprayer operably configured to spray liquid over harvested crops within the enclosed volume; and
a cooling source, operably configured to regulate a temperature within the enclosed volume.

16. The apparatus of claim 13 wherein the load carrying repository comprises an actuated access port that is controlled by the vehicle controller to open to provide access for loading harvested crop portions into the enclosed volume and to close on completion of the loading.

17. The apparatus of claim 1 wherein the vehicle controller is operably configured to cause the robotic vehicle to return to the post-harvesting location for unloading the harvested crop portion when the repository has reached a load carrying capacity based on the quantity signal.

18. A host controller apparatus for monitoring a plurality of robotic vehicles transporting harvested crops within a cultivation area as defined in claim 1, the host controller apparatus comprising:
a receiver operably configured to receive quantity data from the vehicles, the quantity data including quantities of harvested crop portions and an identifier attributing each harvested crop portion to a worker within the cultivation area;
a host processor circuit in communication with the receiver, the host processor circuit including a memory for storing codes that direct the processor circuit to implement a management database, the management database being operably configured store quantity data for each worker; and
wherein the memory further stores codes that direct the host processor circuit to implement a management function that determines a total harvested crop quantity for each worker and generates data indicative of a remuneration owing to each worker based on the total harvested crop quantity.

19. The apparatus of claim 18 wherein the host processor circuit is remotely located and is in communication with the host controller via a network.

20. The apparatus of claim 18 wherein the processor circuit is operably configured to receive routing and performance data from each of the vehicles and to use the data to optimize routing of the vehicles within the cultivated area.

21.-26. (canceled)
